(19) United States
(12) Patent Application Publication
(10) Pub. No.: US 2006/0195797 A1
(43) Pub. Date: Aug. 31, 2006

(54) Efficient document processing selection

(75) Inventors: Michael Yeung, Mission Viejo, CA (US); Manmohan Garg, Cerritos, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/065,790

(22) Filed: Feb. 25, 2005

(51) Int. Cl. G06F 9/00

(52) U.S. Cl. 715/811

(57) ABSTRACT

The present invention is directed to system and method for providing a user with ease of document processing operation selection and ready assistance in retrieving information regarding the document processing operations and options available on a document processing device. The system provides a one-touch document processing operation selection screen, enabling a user to quickly and efficiently select a document processing operation. The system further includes an assistance request screen, allowing a user to request information regarding document processing operations and options. The document processing device receives from an associated user identification data. The user identification data is used to access an associated storage repository and retrieve a personalized display. The personalized display includes at least one icon. The icon represents a document processing operation that the user has previously executed. The user then is prompted, via a user interface, to select an icon corresponding to the type of document processing operation desired. The document processing device then performs the document processing operation immediately following the selection of the icon on the personalized display screen.

### BACKGROUND

This invention is directed to a system and method for selecting a document processing operation. More particularly, this invention is directed to a system and method for use with a document processing device to quickly and easily select a document processing operation.

Document processing devices, such as multifunction peripheral devices, include an ever increasing number of features which enhance the utility of the device in an office environment. these features range from simple printing/faxing/copying with simple options, e.g., duplex, simplex, staple, booklet, to more complex features, such as scanning/fax-receive to network, file, email, send to another printer, and the like. These multifunction peripheral devices include a graphical user interface, enabling the user to select from among the available document processing options. The graphical user interfaces of these multifunction peripheral devices typically include navigating through a large number of menus, searching for the options and features the user desires. The addition of ever increasing features and options to multifunction peripheral devices has resulted in time-wasting navigation for the user to locate the operation he desires. Furthermore, as these new options have been added to multifunction peripheral devices, the average user has little to no familiarity with these new features.

Thus there is a need for a system and method that enables a user to quickly and easily select a document processing operation. Furthermore, there is a need for a system and method for educating a user on the features available on a document processing device.

### SUMMARY OF INVENTION

The present invention is directed to a system and method for quickly and easily selecting a document processing operation on a document processing device. More particularly, the present invention is directed to a system and method for providing a user with ease of document processing operation selection while also providing ready assistance in understanding the document processing operations and options available on a document processing device.

In accordance with the present invention, there is provided a method for generating a user-customized document processor interface. The document processing device generates a display representing the document processing operations available on an associated document processing device. The document processing device receives user identification data from an associated user. The document processing device then receives, from the associated user, selection data representing at least on document processing operation selected by the user. History data, associated with the user identification data an represents user selection data, is then stored by the document processing device. The document processing device then selectively modifies the display to reflect the stored history data.

In a preferred embodiment, the method includes ranking each of the previously selected document processing operations and modifying the display according to the ranking. This method also includes the steps of receiving, from the associated user, selection data representative of at least one assistance request for a document processing operation and retrieving from an associated database, or storage repository, data representative of a response to the at least one assistance request. The display is then modified to display this assistance data in response to the assistance request. In one embodiment, the method further includes the steps of generating a display representing at least one finishing operation available on the associated document processing device and receiving, from the associated user, a selection of at least one of the finishing operations.

Further in accordance with the present invention, there is provided a system for generating a user-customized document processor interface. The system includes means adapted for generating a display representing multiple document processing operations available on an associated document processing device. The system further includes means adapted for receiving user identification data from an associated user, as well as means adapted for receiving, from the associated user, selection data representing at least one document processing operation selected by the associated user. The system also comprises means adapted for storing history data associated with the user identification data, which data represents the selection data, and means adapted for selectively modifying the display in accordance the history data.

In a preferred embodiment, the system also includes means adapted for ranking each of a plurality of previously selected document processing operations, and means adapted for selectively modifying the display in accordance with the ranking means. In a particular embodiment, the system further includes means adapted for receiving, from the associated user, selection data representing an assistance request for a document processing operation and means adapted for retrieving from an associated storage repository data representative of a response to the at least one assistance request. Once the information has been retrieved, the system includes means adapted for modifying the display to display the data representing the response to the assistance request. In one embodiment, the system also includes means adapted for generating a display representing finishing operations available on the associated document processing device, and means adapted for receiving, from the associated user, data representing a selected finishing operation.

In a preferred embodiment, the system also includes means adapted for prompting the associated user to select at least one option corresponding to the selected document processing operation, wherein the document processing operation is selected from a list of document processing operations, means adapted for performing the document processing operation, and means adapted for storing, in the associated user storage repository, an icon representative of the selected document processing operation performed. In one embodiment, the system further comprises means adapted for receiving from the associated user an input representative of an assistance request, means adapted for retrieving from an associated storage repository data representative of a response to the assistance request, and means adapted for displaying on the user interface the data representative of a response to the assistance request.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in a forming a part of the specification, illustrate several aspects of the present invention, and together with the description, serve to explain the principles of the invention.

FIG. 1 is block diagram illustrating a system according to the present invention;

FIG. 2 is a flow chart illustrating a method according to the present invention;

FIG. 3 is a sample template illustrating document processing operation selection screen in accordance with the present invention;

FIG. 4 is a sample template illustrating an assistance screen in accordance with the present invention; and

FIG. 5 is a sample template illustrating a personalized one-touch display in accordance with the present invention.

### DETAILED DESCRIPTION OF THE PREFERRED EMBODIMENT

This invention is directed to a system and method for quickly and easily selecting a document processing operation on a document processing device. In particular, this invention is directed to a system and method for providing a user with ease of document processing operation selection while also providing ready assistance in understanding the document processing operations and options available on a document processing device. Preferably, the document processing device is a multifunction peripheral device, capable of providing scanning, copying, facsimile and printing functions to a user. Preferably, the multifunction peripheral device includes a touch-screen user interface.

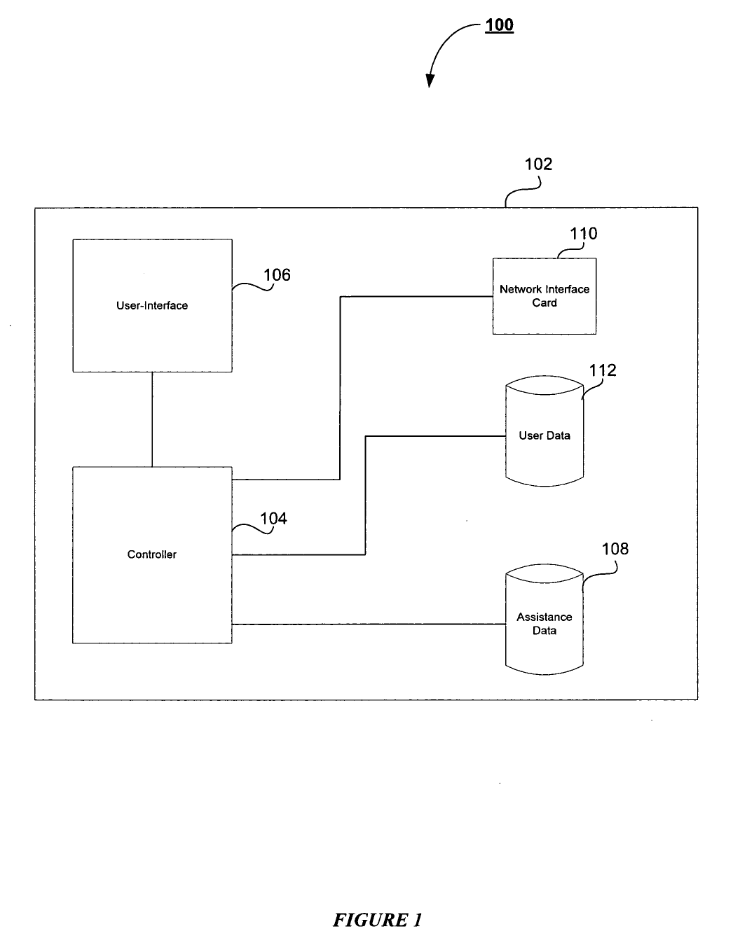

Turning now to the drawings, wherein the illustrations are for illustrating the preferred embodiment only, and not for limiting the same, a diagram illustrating the system 100 of the present invention is shown in FIG. 1. In the present invention, a user is provided access to a multifunction peripheral device 102. Suitable commercially available document processing devices include, but are not limited to, the Toshiba e-Studio Series Controller. The multifunction peripheral device 102 includes a controller 104, which functions to control the operations of the multifunction peripheral device 102. The controller 104 is capable of being externally or internally coupled to the multifunctional peripheral device 102. In addition to the controller 104, the multifunctional peripheral device 102 also includes a user interface 106, an assistance data storage device 108, a network interface card 110 and a user data storage device 112.

The assistance data storage device 108 and the user data storage device 112 are any mass data storage devices known in the art, for example an integrated magnetic hard drive or other dynamic or static memory storage device, e.g., flash memory. Accordingly, the assistance data storage device 108 and the user data storage device 112 are shown in FIG. 1 as being integrated within the multifunctional peripheral device 102. The skilled artisan will appreciate that the data storage devices 108 and 112 are equally capable of being externally connected to the multifunctional peripheral device 102 without departing from the scope of the present invention. The skilled artisan will further appreciate that the assistance data storage device 108 and the user data storage device 112 are capable of being implemented on the same physical drive, logically separated into different data storage segments, such as databases. The user interface 114 suitably comprises a touch-screen or other input/output device capable of displaying and receiving user instructions for the operation of the multifunctional peripheral device 102. The multifunction peripheral device 102 also includes a network interface card 110. The network interface card 110 is any network interface card known in the art capable of connecting the multifunction peripheral device 102 to a computer network. It will be appreciated by those skilled in the art that the network interface card 110 enables the multifunction peripheral device 102 to externally connect to various data storage repositories or databases, without the need to internally incorporate large mass storage devices.

The controller 104 of the multifunction peripheral device 102 coordinates the retrieval and displaying of data to the user interface 106, as well as the processing of user entered information at the user interface 106. When a user accesses the multifunction peripheral device 102 via the user interface 106, the controller 104 receives the user's identifying information and compares the input information with information stored in the user data storage device 112. Preferably, the user data storage device 112 is a storage repository or database containing user identification, PIN numbers, and associated multifunction peripheral device usage information. In addition, the assistance data storage device 108 suitably contains a help storage repository or database containing information relating the functions of the multifunction peripheral device 102, as well as the various options the multifunction peripheral device 102 is capable of providing to the user.

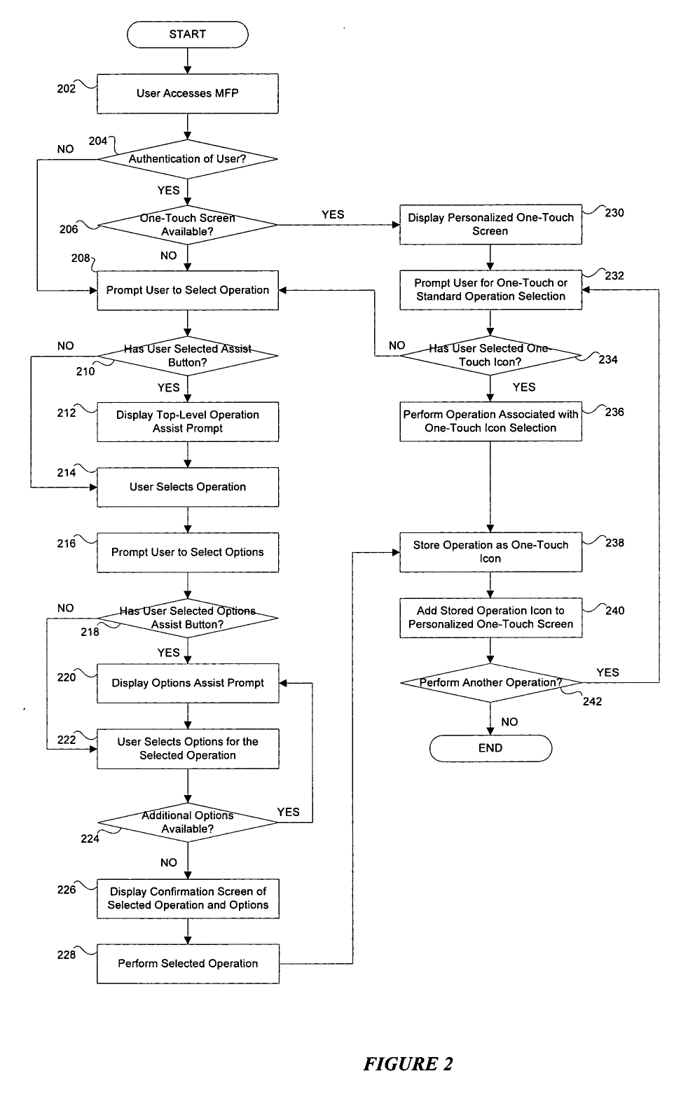

The touch screen user interface 106 is capable of displaying personalized menu depicting one or more icons corresponding to the one-touch operation provided by the present invention. Each one-touch icon corresponds to a document processing operation that the user has selected during past uses of the multifunction peripheral device 102. The user data storage device 112 stores the personalized menu corresponding to each user. In addition, the touch screen user interface 106 also enables the controller 104 to display assistance information, such as what a particular operation does to a document, or what a particular option adds to the output of a document, retrieved from the assistance data storage device 108. The system of the present invention will better be understood in light of the method set forth with respect to FIG. 2.

Referring now to FIG. 2, there is illustrated a flowchart showing the method in accordance with the present invention. Beginning at step 202, a user accesses the multifunction peripheral device 102 via any means as is known in the art. At step 204, a determination is made whether authentication of the user is required. When authentication is required at step 204, the user is prompted to input identifying information, such as a user ID and password, a PIN number or the like. This information enables the multifunction peripheral device 102 to determine the identity of the user. In one embodiment, the multifunction peripheral device 102 includes a card reader, capable of ascertaining the identity of the user from a magnetic card or smart card, obviating the need to input a password/PIN at the touch screen interface 106. Once the user has been identified at step 204, the multifunction peripheral device 102 then determines at determination step 206, whether the user has a one-touch personalized menu screen stored in the user data storage device 112. When authentication of the user is not required to use the assist features of the present invention at step 204, flow proceeds immediately to the selection of a document processing operation at step 208, explained in more detail below. As will be understood by those skilled in the art, the multifunction peripheral device 102, via the controller 104, searches the user data storage device 112 using the input user identity to locate the personalized menu screen corresponding to the user.

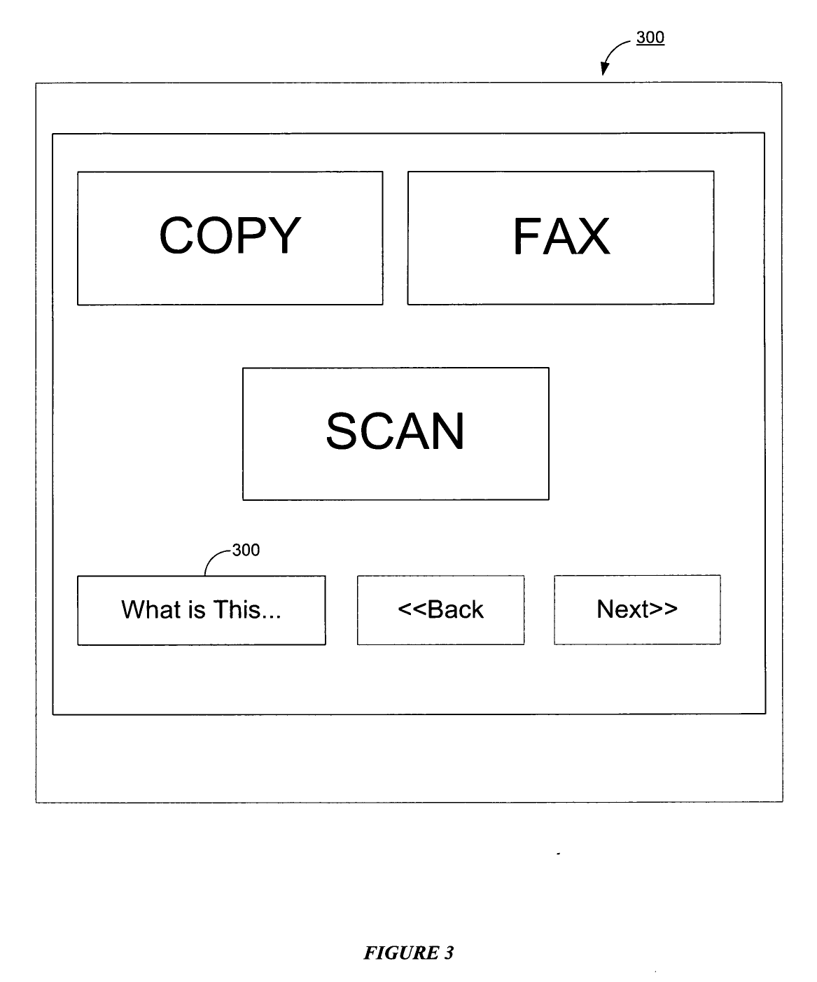

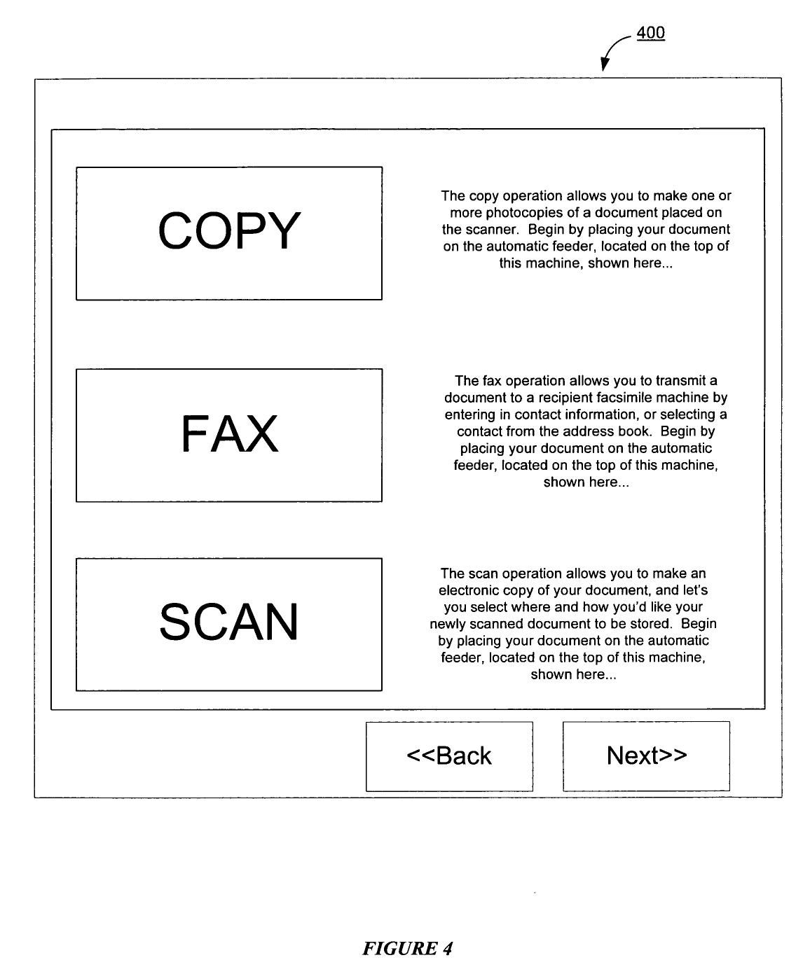

A negative determination at step 206 instructs the multifunction peripheral device 102 to prompt the user at step 208 to select a document processing operation. The document processing operation is any document processing operation known in the art capable of being performed by the multifunction peripheral device 102, such as and without limitation, faxing, scanning, printing and copying. FIG. 3 shows a template illustrating the document processing operation selection screen 300. As shown in FIG. 3, the template includes an assistance request button 302. When a user desires additional information regarding the document processing operations the multifunction peripheral device 102 is capable of performing, the user depresses the assistance button 302 via the touch screen interface 106. Once the user has selected the document processing operation, the multifunction peripheral device 102 then determines at step 210 whether the user has depressed the assistance request button 302. When the user has requested assistance, the touch screen interface 106 displays a top-level, e.g., scan, fax, copy, print, selection prompt, detailing the functions available through each of these operations at step 212. FIG. 4 is a sample template illustrating an assistance screen 400 in accordance with the present invention. As shown in FIG. 4, the assistance screen 400 illustrates the help information to facilitate the user's understanding of the available document processing operations of the multifunction peripheral device 102.

The user then selects the desired document processing operation at step 214. Returning to step 210, when the user has not selected to receive assistance, the process proceeds to step 214 and the user selects the desired document processing operation. Having selected the desired document processing operation, the user is then prompted at step 216 to select one or more options corresponding to the selected document processing operation. For example, when the user has selected the copy operation, the options displayed correspond thereto, including, without limitation, stapling, duplex/simplex, hole-punch, and other finishing features. At step 218, a determination is made as to whether the user has selected to receive assistance regarding the available options. When the user has requested assistance, the multifunction peripheral device 102 retrieves, from the assistance data storage device 108, information relating to each of the available options. This information is then displayed at step 220 to instruct the user as to the functions of each available option, the user then selects one or more options at step 222. When a negative determination is made at step 218, the method proceeds to step 222, wherein the user selects one or more options for the selected document processing operation.

At step 224, a determination is made whether additional options are available. When additional options are available, the method returns to step 220 and displays the options assist prompt. For example, when the user selects the assist prompt, information regarding the available options is displayed, such as what finishing options for a copy job are available. When the user selects the sort option, the assist prompt displays other finishing options corresponding to the selected sort option, such as stapling, thereby introducing the user to the additional functionality and options of the multifunction peripheral device 102. When no additional options are available, the method proceeds to step 226, where the multifunction peripheral device 102 displays a confirmation screen showing the user the selected operation and finishing options selected. The user confirms the information shown via any means known in the art and the multifunction peripheral device 102 performs the selected operation and finishing options at step 226.

In accordance with the present invention, once the user has initiated the document processing operation, the operation and selected options are stored as a one-touch icon at step 238. The skilled artisan will appreciate that the operation and selected options are stored by the multifunction peripheral device 102 in the user data storage device 112 corresponding to the user identity information input at step 204. The one-touch icon is then added to the personalized menu corresponding to the user at step 240. The method then proceeds to determine, at step 242, whether the user desires to perform an additional document processing operation. When the user desires to perform another operation, flow proceeds back to step 232, where the user is prompted to select a one-touch icon or a standard document processing operation. Should the user decide that no further document processing operations are desired, the process terminates.

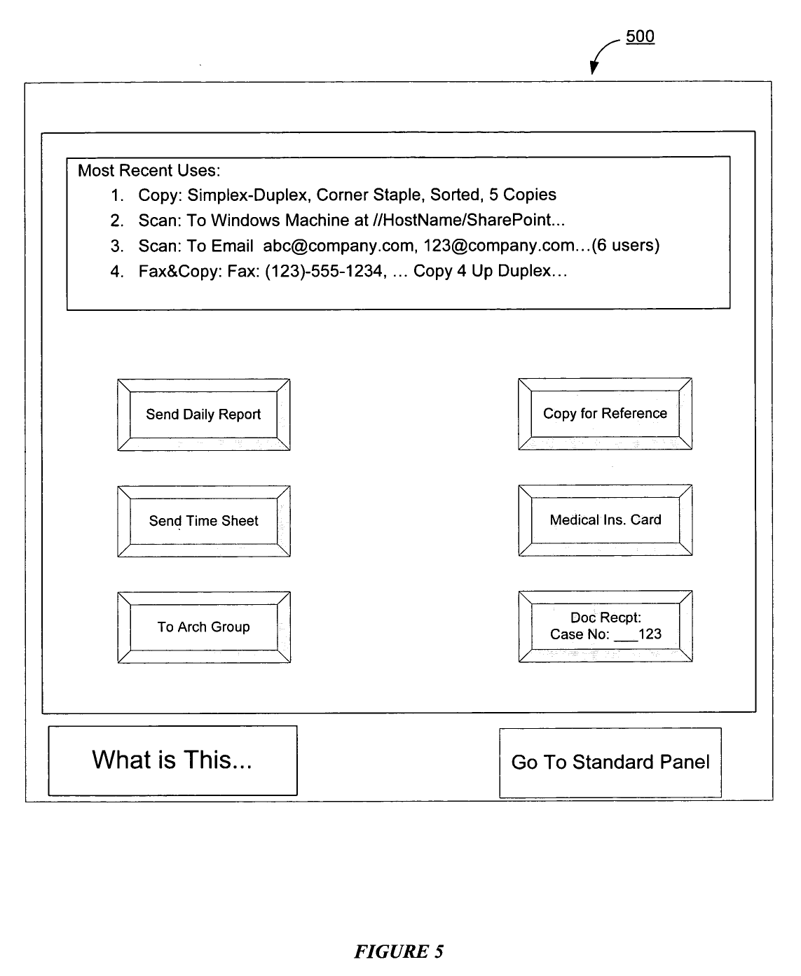

Returning to step 206, a determination that a personalized menu is available from the user data storage device 112, the menu is retrieved and displayed at step 230. As shown in FIG. 5, the one-touch display screen 500 suitably includes various one-touch icons corresponding to previously selected operations, facilitating the quick execution of repetitive document processing operations. In addition, the personalized menu suitably includes menu selections corresponding to main menu selections, such as copy, fax, printing, scanning, and the like. The user is then prompted at step 232 to select a one-touch icon or a standard document processing operation. A determination is made at step 234 that the user has not selected a one-touch icon, the method proceeds to step 208, wherein the user is prompted to select a document processing operation. The method then proceeds as set forth above. When the determination is made at step 234 that the user has selected a one-touch icon, the multifunction peripheral device 102 retrieves the operation and options from the user data storage device 112 and performs the associated operation at step 236. The process then proceeds to step 238, with the operation stored in the user data storage device 112, thereby updating the usage data associated with the selected icon. The method continues through steps 240 and 242, as set forth above.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A method for generating a user-customized document processor interface comprising the steps of:
generating a display representative of a plurality of document processing operations available on an associated document processing device;
receiving user identification data from an associated user;
receiving, from the associated user, selection data representative of at least one document processing operation selected by the associated user;
storing history data associated with the user identification data, which history data is representative of the selection data; and
selectively modifying the display in accordance the history data.

2. The method of claim 1 further comprising the steps of:
ranking each of a plurality of previously selected document processing operations; and
selectively modifying the display in accordance with the ranking means.

3. The method of claim 1 wherein the display is a touch screen user interface.

4. The method of claim 2, further comprising the steps of:
receiving, from the associated user, selection data representative of at least one assistance request for a document processing operation;
retrieving from an associated storage repository data representative of a response to the at least one assistance request; and
selectively modifying the display to display the data representative of the response to the at least one assistance request.

5. The method of claim 4, further comprising the steps of:
generating a display representative of at least one finishing operation available on the associated document processing device; and
receiving, from the associated user, selection data representative of the at least one finishing operation.

6. The method of claim 1, wherein the document processing device includes a facsimile device, a copying device, a scanning device, a printing device, and a multifunction peripheral device.

7. The method of claim 1, wherein the document processing operations include printing, copying, faxing, scanning, optical character recognition, and document distribution.

8. A system for generating a user-customized document processor interface comprising:
means adapted for generating a display representative of a plurality of document processing operations available on an associated document processing device;
means adapted for receiving user identification data from an associated user;
means adapted for receiving, from the associated user, selection data representative of at least one document processing operation selected by the associated user;
means adapted for storing history data associated with the user identification data, which history data is representative of the selection data; and
means adapted for selectively modifying the display in accordance the history data.

9. The system of claim 8 further comprising:
means adapted for ranking each of a plurality of previously selected document processing operations; and
means adapted for selectively modifying the display in accordance with the ranking means.

10. The system of claim 8 wherein the display is a touch screen user interface.

11. The system of claim 9, further comprising:
means adapted for receiving, from the associated user, selection data representative of at least one assistance request for a document processing operation;
means adapted for retrieving from an associated storage repository data representative of a response to the at least one assistance request; and
means adapted for selectively modifying the display to display the data representative of the response to the at least one assistance request.

12. The system of claim 11, further comprising:
means adapted for generating a display representative of at least one finishing operation available on the associated document processing device; and
means adapted for receiving, from the associated user, selection data representative of the at least one finishing operation.

13. The system of claim 8, wherein the document processing device includes a facsimile device, a copying device, a scanning device, a printing device, and a multifunction peripheral device.

14. The system of claim 8, wherein the document processing operations include printing, copying, faxing, scanning, optical character recognition, and document distribution.

15. A computer-readable medium of instructions with computer-readable instructions stored thereon for generating a user-customized document processor interface comprising:
instructions for generating a display representative of a plurality of document processing operations available on an associated document processing device;
instructions for receiving user identification data from an associated user;
instructions for receiving, from the associated user, selection data representative of at least one document processing operation selected by the associated user;
instructions for storing history data associated with the user identification data, which history data is representative of the selection data; and
instructions for selectively modifying the display in accordance the history data.

16. The computer-readable medium of instructions with computer-readable instructions stored thereon of claim 15 further comprising:
instructions for ranking each of a plurality of previously selected document processing operations; and
instructions for selectively modifying the display in accordance with the ranking means.

17. The computer-readable medium of instructions with computer-readable instructions stored thereon of claim 15, wherein the display is a touch screen user interface.

18. The computer-readable medium of instructions with computer-readable instructions stored thereon of claim 16, further comprising:
instructions for receiving, from the associated user, selection data representative of at least one assistance request for a document processing operation;
instructions for retrieving from an associated storage repository data representative of a response to the at least one assistance request; and
instructions for selectively modifying the display to display the data representative of the response to the at least one assistance request.

19. The computer-readable medium of instructions with computer-readable instructions stored thereon of claim 18, further comprising:
instructions for generating a display representative of at least one finishing operation available on the associated document processing device; and
instructions for receiving, from the associated user, selection data representative of the at least one finishing operation.

20. The computer-readable medium of instructions with computer-readable instructions stored thereon of claim 15, wherein the document processing device includes a facsimile device, a copying device, a scanning device, a printing device, and a multifunction peripheral device.

21. The computer-readable medium of instructions with computer-readable instructions stored thereon of claim 15, wherein the document processing operations include printing, copying, faxing, scanning, optical character recognition, and document distribution.

22. A computer-implemented method for generating a user-customized document processor interface comprising the steps of:
generating a display representative of a plurality of document processing operations available on an associated document processing device;
receiving user identification data from an associated user;
receiving, from the associated user, selection data representative of at least one document processing operation selected by the associated user;
storing history data associated with the user identification data, which history data is representative of the selection data; and
selectively modifying the display in accordance the history data.

23. The computer-implemented method of claim 22 further comprising the steps of:
ranking each of a plurality of previously selected document processing operations; and
selectively modifying the display in accordance with the ranking means.

24. The computer-implemented method of claim 22 wherein the display is a touch screen user interface.

25. The computer-implemented method of claim 23, further comprising the steps of:
receiving, from the associated user, selection data representative of at least one assistance request for a document processing operation;
retrieving from an associated storage repository data representative of a response to the at least one assistance request; and
selectively modifying the display to display the data representative of the response to the at least one assistance request.

26. The computer-implemented method of claim 25, further comprising the steps of:
generating a display representative of at least one finishing operation available on the associated document processing device; and
receiving, from the associated user, selection data representative of the at least one finishing operation.

27. The computer-implemented method of claim 22, wherein the document processing device includes a facsimile device, a copying device, a scanning device, a printing device, and a multifunction peripheral device.

28. The computer-implemented method of claim 22, wherein the document processing operations include printing, copying, faxing, scanning, optical character recognition, and document distribution.
